(19) United States
(12) Patent Application Publication
(10) Pub. No.: US 2008/0232748 A1
(43) Pub. Date: Sep. 25, 2008

(54) Fibre-Optic Package and Method of Making the Same

(75) Inventor: Philip John Nash, Surrey (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Qinetiq Limited

(21) Appl. No.: 12/067,288

(22) PCT Filed: Oct. 3, 2006
(86) PCT No.: PCT/GB06/03668

§ 371 Date: Mar. 18, 2008

(30) Foreign Application Priority Data
Oct. 11, 2005 (GB) 0520590.1

(51) Int. Cl. G02B 6/255

(52) U.S. Cl. 385/96

(57) ABSTRACT

A fibre-optic package comprises at least two fibre optic devices or components (102, 104, 106, 118, 120, 122, 124) coupled together by fused-fibre coupling. The package typically comprises two or more fibre optic accelerometers, and may be of reduced size compared to fibre-optics packages of the prior art, due to the reduced length of optical fibre required to connect the devices or components.

The present invention relates to fibre-optic packages and to methods of making fibre-optic packages.

Many types of fibre-optic package comprise a plurality of individual fibre-optic devices which are optically coupled together in series such that an output fibre of one individual fibre-optic device is coupled to an input fibre of another device. For example, two or three fibre-optic accelerometers of a type described in published international application PCT/GB2005/000078 (publication number WO 2005/068950 A1) may be coupled together by reflective couplers to form an accelerometer package for detecting components of acceleration along two or three mutually orthogonal directions.

Packages of this type are typically manufactured by arranging pre-fabricated devices within a package and then optically coupling individual devices together by fusion splicing of input and output fibres. Where another component (e.g. a fibre-coupled mirror) is required to be coupled into the optical path between two devices, two fusion splices are required: one to couple an output fibre of a first device to one end of the component, and a second to couple the other end of the component to an input fibre of a second device.

Fusion splicing is time consuming, complicated and expensive to carry out on a large scale. Two fibres have to be aligned, for example in a V-groove support, before being fused, for example by an arc. The expense of such splicing accounts for most of the cost of a finished package and this inhibits the commercial viability and take-up of fibre-optic packages in a number of potential applications. A fusion splice is also unreliable over time and a potential failure point in a finished package. Furthermore, fusion splices introduce additional undesirable optical loss. Additionally, the nature of the fusion splicing process is such that the fibres to be joined must be relatively long to allow for multiple failures during splicing and to allow use of fusion splicing machinery. This means that connecting fibres between optically adjacent devices in a package are generally much longer than is necessary for these fibres to perform their function. Excess lengths of fibre must then be stowed within the finished package, resulting in a package size that is unnecessarily large.

It is an object of the invention to ameliorate at least one of these problems. According to a first aspect of the present invention this object is achieved by a fibre-optic package comprising first and second fibre-optic devices or components having first and second optical fibres respectively, and wherein the first and second fibres are coupled by fused-fibre coupling.

In this specification, “fused-fibre coupling” of two fibres refers to the coupling of the two fibres by joining respective lengths of each fibre together such that, after coupling, a portion of radiation carried in one fibre may pass into the other fibre by evanescent coupling of radiation. Fused-fibre coupling may be achieved in a number of ways, for example by winding the two lengths of fibre around each other and then pulling them in a flame (i.e. fused-taper coupling), or by polishing the lengths of fibre and then gluing them next to each other.

The first and second fibre-optic devices or components may be fibre-optic devices of any kind such as temperature sensors, pressure sensors etc, or passive components such as in-fibre gratings. Since the first and second fibres are fused-fibre coupled, they can be of generally of shorter length in the finished package than would be the case if they were fusion spliced. This allows packages of the invention to be of reduced size compared to those in the prior art. The finished package is also more reliable since fused-fibre coupling provides coupling of greater longevity than fusion splicing. This is particularly important where the package is be deployed in inaccessible and/or dangerous environments.

The package may further comprise a third fibre-optic device or component having a third optical fibre wherein the third optical fibre is coupled to either the first optical fibre or to the second optical fibre by fused-fibre coupling. Where a package is required to have a device/component coupled to two other devices/components, this allows further package size reduction and increased reliability compared to prior art packages.

The first and second devices may be respectively first and second fibre-optic accelerometers and the third device a fibre-coupled reflector, the first and second fibres being respectively an output fibre of the first accelerometer and an input fibre of the second accelerometer and the package further comprising a second fibre-coupled reflector fused-fibre coupled to an input fibre of the first accelerometer and a third fibre-coupled reflector fused-fibre coupled to an output fibre of the second accelerometer. This provides a fibre-optic accelerometer package having two individual fibre-optic accelerometers.

To provide an accelerometer package having three individual fibre-optic accelerometers, the package may further comprise a third fibre-optic accelerometer having an input fibre fused-fibre coupled to the output fibre of the second accelerometer such that the third fibre-coupled reflector is coupled to the optical path between the second and third accelerometers, and a fourth fibre-coupled reflector fused-fibre coupled to an output fibre of the third accelerometer. Alternatively, the output fibre of the third accelerometer may be cleaved (or cleaved and then the exposed end silvered) to form a reflective end thereof.

The fibre-optic accelerometers are preferably oriented so as to detect components of acceleration of the package along substantially mutually orthogonal directions.

The fibre-coupled reflector or reflectors may each comprise a length of fibre having a cleaved end, or a cleaved and silvered end.

According to the first aspect of the invention, a fibre-optic package is provided, the package comprising first and second fibre-optic devices or components having first and second optical fibres respectively, and wherein the first and second fibres are coupled by fused-fibre coupling. The package may further comprise a third fibre-optic device/component directly optically connected to the first device/component by the first optical fibre. This provides the advantage that no coupling of fibres is required to optically connect the first and third devices/components. This may be achieved by fabricating the first and third devices together using a single length of optical fibre to form the first and third devices as well as the optical fibre connecting them.

The first and third devices may be respectively first and second fibre-optic accelerometers and the second device a fibre-coupled reflector, the package further comprising a second fibre-coupled reflector fused-fibre coupled to an input fibre of the first accelerometer and a third fibre-coupled reflector fused-fibre coupled to an output fibre of the second accelerometer. The first and second accelerometers may be formed using a single optical fibre.

To provide an accelerometer package having three individual fibre-optic accelerometers, a third fibre-optic accelerometer may be directly optically connected to the output fibre of the second accelerometer and a fourth fibre-coupled reflector fused-fibre coupled to an output fibre of the third accelerometer. For example, the three individual fibre-optic accelerometers may be formed with a single optical fibre. Instead of providing a fourth fibre-coupled reflector, the output fibre of the third accelerometer may be cleaved (or cleaved and then the exposed end silvered) to form a reflective end thereof.

The fibre-optic accelerometers are preferably oriented so as to detect components of acceleration of the package along substantially mutually orthogonal directions.

The fibre-coupled reflector or reflectors may each comprise a length of fibre having a cleaved end, or a cleaved and silvered end.

A second aspect of the invention provides a method of fabricating a fibre-optic package comprising the steps of:
(i) taking first and second fibre-optic devices or components having first and second optical fibres respectively; and
(ii) coupling the first and second fibres by fused-fibre coupling.

The method may comprise the steps of:

(i) forming first, second and third individual fibre-optic accelerometers from a single optical fibre;
(ii) fused-fibre coupling a first fibre-coupled reflector to the fibre between the first and second accelerometers;
(iii) fused-fibre coupling a second fibre-coupled reflector to the fibre between the second and third accelerometers;
(iv) fused-fibre coupling a third fibre-coupled reflector to the fibre at an input of the first accelerometer; and
(v) fused-fibre coupling a fourth fibre-coupled reflector to the fibre at an output of the third accelerometer,
thus forming an accelerometer package.

The step of coupling two fibres may be effected by fused-taper coupling, i.e. by twisting a length of one of the fibres around a length of the other and heating the region in which the fibres overlap to form a coupled region. The coupled region is preferably packaged itself.

Embodiments of the invention are described below by way of example only and with reference to the accompanying drawings in which:

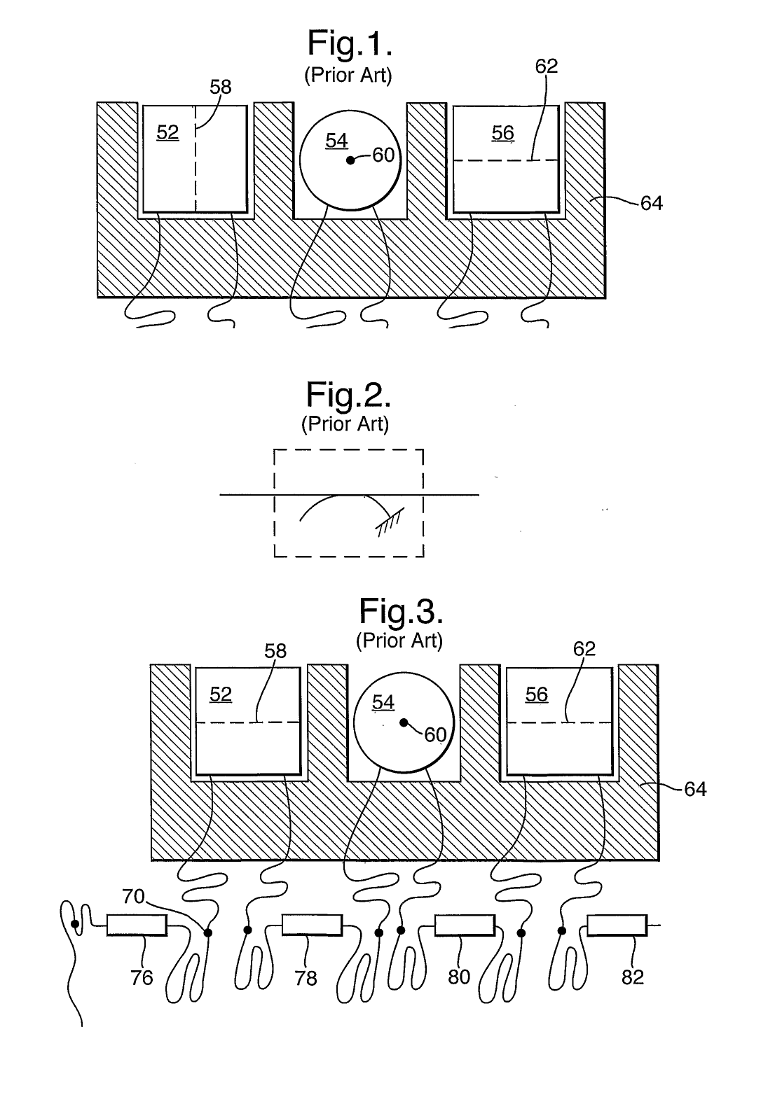

FIGS. 1 to 4 illustrates stages in manufacture of a fibre-optic accelerometer package of the prior art;

FIGS. 5 to 8 illustrate stages in manufacture of a first example fibre-optic accelerometer package of the invention;

FIGS. 9 to 11 illustrate stages in manufacture of a second example fibre-optic accelerometer package of the invention; and

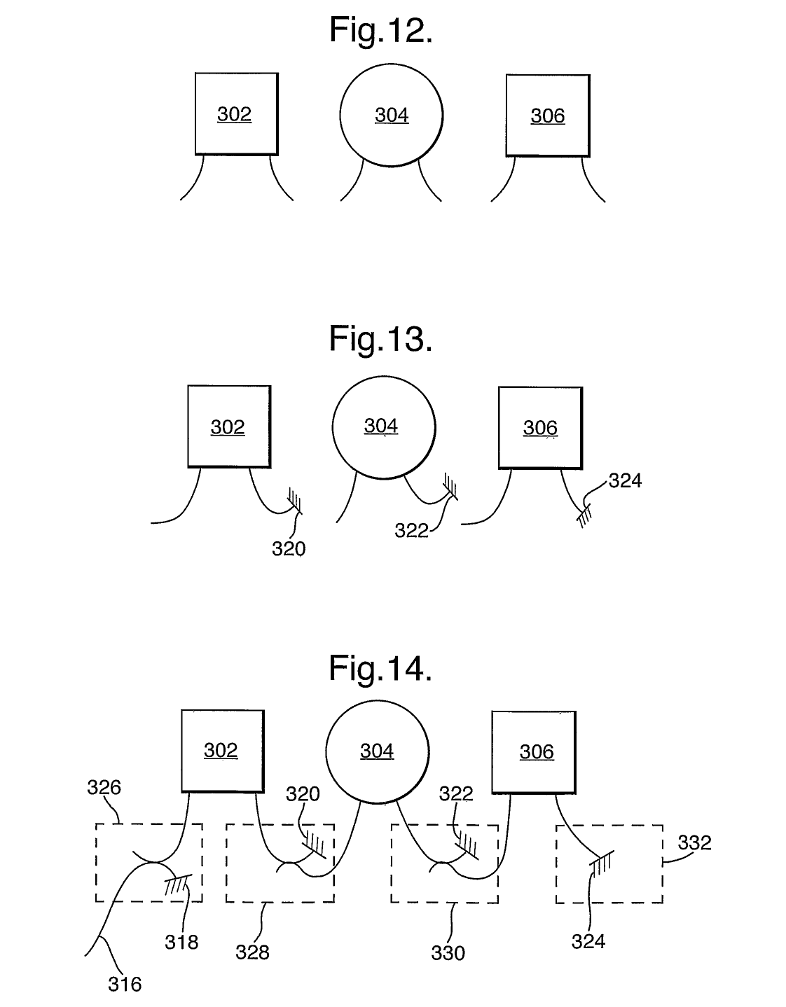

FIG. 12 to 14 illustrate stages in manufacture of a third example fibre-optic accelerometer package of the invention.

FIG. 1 shows a stage in construction of a fibre-optic accelerometer package of the prior art. Three individual fibre-optic accelerometers 52, 54, 56 of a type having a coil of optical fibre are placed in a support cradle 64. Respective axes 58, 60, 62 of the coils of the accelerometers are substantially mutually perpendicular. Four pre-fabricated reflective couplers 76, 78, 80, 82, each having the structure shown in FIG. 2, are connected to input and output fibres of the individual accelerometers 52, 54, 56 as shown in FIG. 3. This is achieved by seven fusion splices such as 70. Substantial excess lengths of fibre connecting each reflection coupler to adjacent accelerometers are required to allow for multiple failures of the fusion splices and to allow use of fusion splicing apparatus.

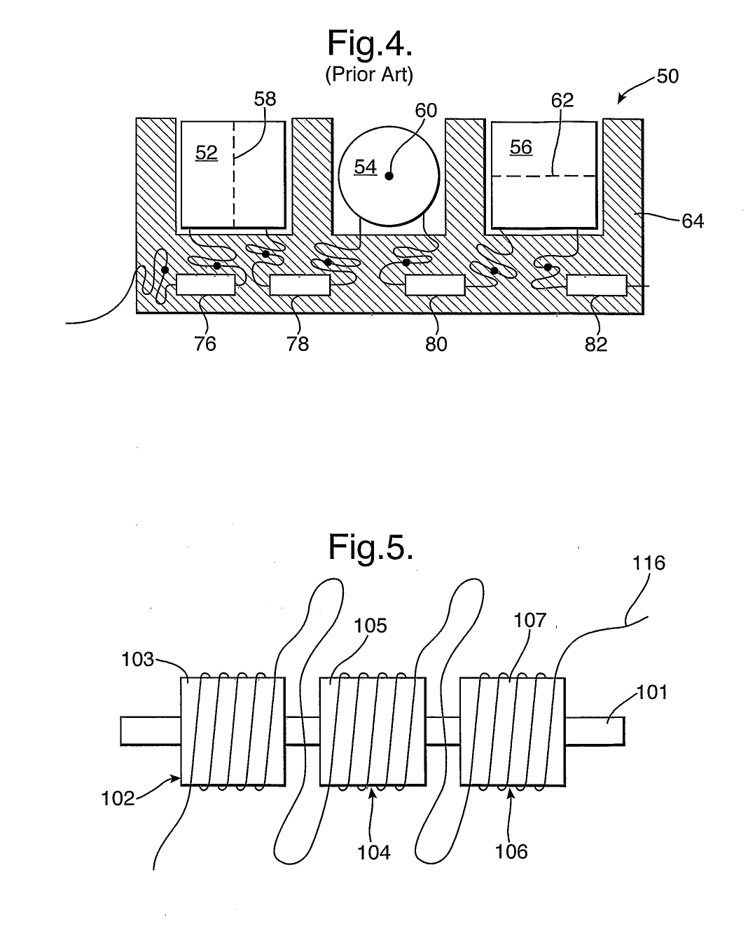

As shown in FIG. 4, the reflection couplers 76, 78, 80, 82 and the connecting fibres are then stowed in the cradle during formation of the finished accelerometer package 50.

Referring to FIG. 5, a three-component accelerometer is formed by winding a single optical fibre 116 onto each of three hollow cylindrical formers 103, 105, 107 which are mounted on a temporary support bar 101. The wound formers are then finished to produce three individual fibre-optic accelerometers 102, 104, 106 having a single fibre 116 connecting them and forming their respective detection coils. Alternatively, the formers may be removed from the support bar 101 before being finished to produce completed accelerometers. A suitable example architecture for the accelerometers 102, 104, 106 is described in published international application PCT/GB2005/000078 (publication number WO 2005/068950 A1).

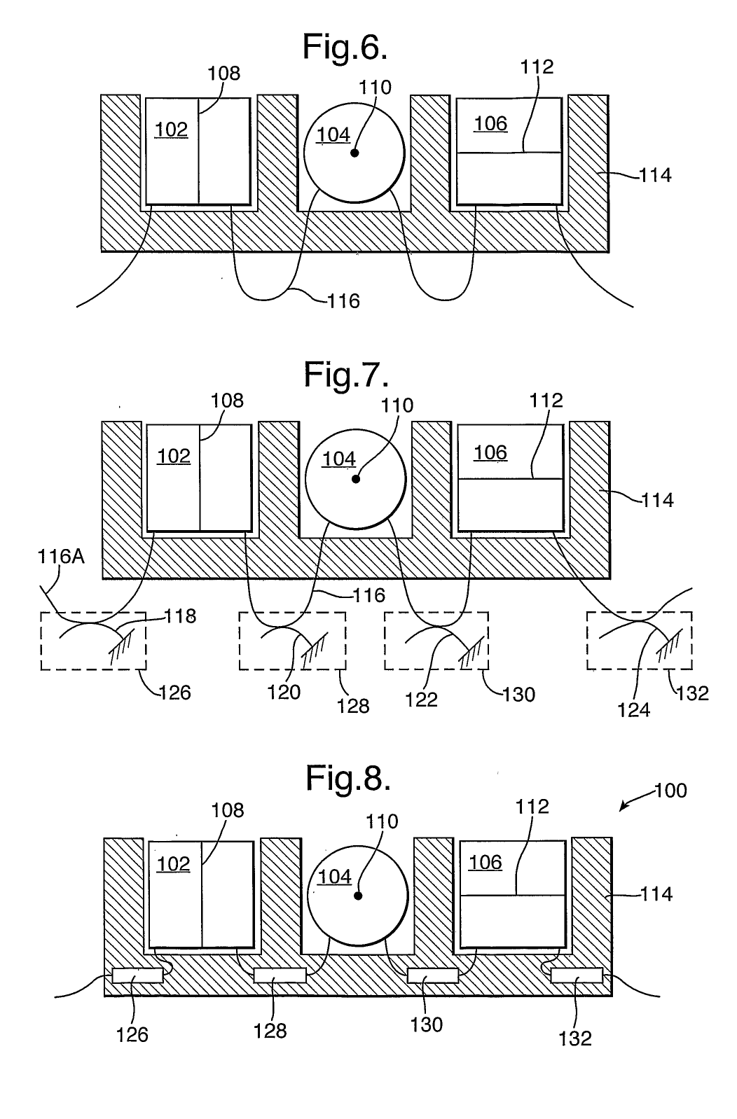

Referring to FIG. 6, the individual accelerometers are fixedly mounted within a support cradle 114, such that their axes are substantially mutually perpendicular. This allows the finished package to detect components of acceleration of the package along three substantially mutually perpendicular directions.

Referring to FIG. 7, four fibre coupled reflectors 118, 120, 122, 124 are then coupled to the fibre 116 near the ends thereof and at the portions thereof connecting optically adjacent accelerometers by means of fused-fibre coupling. To achieve this, a portion of the fibre of a fibre-coupled reflector is wound around, or otherwise located adjacent to, a portion of the fibre 116 to which it is to be coupled, and heated, for example by a flame. Each fibre-coupled reflector may be formed for example by careful cleaving of an end of a fibre, and possibly also silvering the end.

The fibre coupled reflectors 118, 120, 122, 124 and the portions of the fibre 116 to which they are attached are then individually packaged to form sub-packages 126, 128, 130, 132 which are stowed within the cradle 114 to form a substantially finished fibre-optic accelerometer package 100 of the invention, as illustrated in FIG. 8.

Coupling of the fibre-coupled reflectors 118, 120, 122, 124 in the orientation shown in FIG. 7 defines end 116A of fibre 116 as the input end of the finished fibre-optic accelerometer package 100.

FIGS. 9 to 11 show stages in manufacture of a second example fibre-optic accelerometer package of the invention.

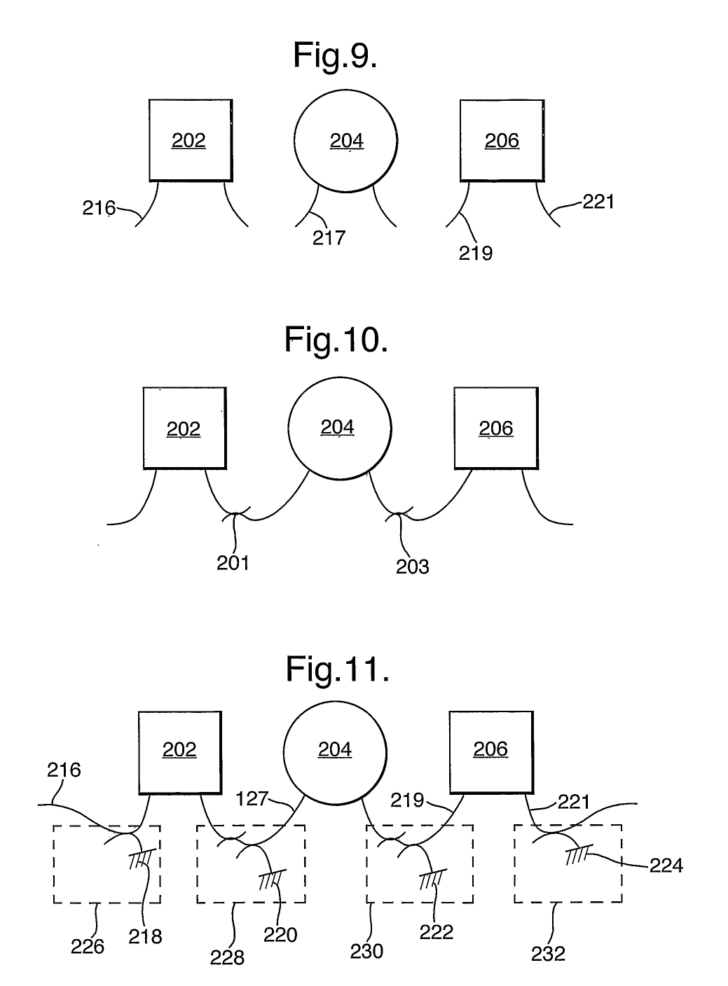

Referring to FIG. 9, three individual fibre-optic accelerometers 202, 204, 206 are arranged in support cradle (not shown) with their detection axes (not shown) substantially mutually perpendicular. As shown in FIG. 10, input and output fibres of adjacent accelerometers are coupled by fused-fibre coupling at 201 and 203.

Referring to FIG. 11, fibre-coupled reflectors 218, 220, 222 are coupled to first ends 216, 217, 219 of the fibre of accelerometers 202, 204, 206 respectively by fused-fibre coupling. A fibre-coupled reflector 224 is coupled to a second end 221 of the fibre of accelerometer 226, also by fused-fibre coupling. The fibre-coupled reflectors 218, 220, 222, 224 and respective neighbouring coupled sections of fibre are then packaged to form sub-packages 226, 228, 230, 232 which are stowed within the accelerometer package.

The orientation of fibre-coupled mirrors 218, 220, 222, 224 defines fibre 216 as the input fibre of the finished accelerometer package.

FIG. 12 to 14 shows stages in manufacture of a third example fibre-optic accelerometer package of the invention. Individual fibre-optic accelerometers 302, 304, 306 are fixedly mounted in a support cradle (not shown) with their axes substantially mutually perpendicular (FIG. 12). As shown in FIG. 13, one end of the optical fibre of each accelerometer 302, 304, 306 is cleaved (and possibly also silvered) to form reflectors 320, 322, 324. Referring to FIG. 14, adjacent accelerometers are then coupled by fused-fibre coupling, and a fibre-coupled reflector 318 is also coupled to the free end of the fibre of accelerometer 302 by fused-fibre coupling. Fibre 316 is the input fibre for the finished accelerometer package. Coupled regions of the fibres and adjacent reflectors, and also reflector 324, are then formed into sub-packages 326, 328, 330, 332 and stowed in the finished fibre-optic accelerometer package.

1. A package comprising two or more fibre optic accelerometers, said accelerometers connected in an array with one or more fibre optic connecting portions extending between accelerometers, wherein at least one of said connecting portions includes a fused fibre coupling.

2. A package according to claim 1, wherein said connecting portions form part of a single continuous fibre extending through the array, one or more reflectors being coupled to a connecting portion of said continuous fibre by fused fibre coupling.

3. A package according to claim 1, wherein each accelerometer comprises an optic fibre having at least one exposed end, and wherein at least one of said connecting portions is formed by fused fibre coupling the exposed ends of two connected accelerometers.

4. A package according to claim 3, wherein said output end of said adjacent accelerometer is cleaved so as to form a reflector.

5. A fibre-optic package comprising first and second fibre-optic devices or components having first and second optical fibres respectively, wherein the first and second fibres are coupled by fused-fibre coupling.

6. A package according to claim 5, further comprising a third fibre-optic device or component having a third optical fibre and wherein the third optical fibre is coupled to either the first optical fibre or to the second optical fibre by fused-fibre coupling.

7. A package according to claim 6, wherein the first and second devices are respectively first and second fibre-optic accelerometers, the third device is a fibre-coupled reflector and the first and second fibres are respectively an output fibre of the first accelerometer and an input fibre of the second accelerometer and wherein the package further comprises a second fibre-coupled reflector fused-fibre coupled to an input fibre of the first accelerometer and a third fibre-coupled reflector fused-fibre coupled to an output fibre of the second accelerometer.

8. A package according to claim 7, further comprising a third fibre-optic accelerometer having an input fibre fused-fibre coupled to the output fibre of the second accelerometer such that the third fibre-coupled reflector is coupled to the optical path between the second and third accelerometers, and a fourth fibre-coupled reflector fused-fibre coupled to an output fibre of the third accelerometer.

9. A package according to claim 7, wherein the accelerometers are oriented so as to detect components of acceleration of the package along substantially mutually orthogonal directions.

10. A package according to claim 7, wherein each fibre-coupled reflector comprises an optical fibre having an end cleaved to provide reflection of radiation within the optical fibre.

11. A package according to claim 5, further comprising a third fibre-optic device or component directly optically connected to the first device or component by the first optical fibre.

12. A package according to claim 11, wherein the first and third devices are first and second fibre-optic accelerometers and the second device is a fibre-coupled reflector and wherein the package further comprises a second fibre-coupled reflector fused-fibre coupled to an input fibre of the first accelerometer and a third fibre-coupled reflector fused-fibre coupled to an output fibre of the second accelerometer.

13. A package according to claim 12, further comprising a third fibre-optic accelerometer optically connected to the output fibre of the second accelerometer and a fourth fibre-coupled reflector fused-fibre coupled to an output fibre of the third accelerometer.

14. A package according to claim 12, wherein the accelerometers are oriented so as to detect components of acceleration of the package along substantially mutually orthogonal directions.

15. A package according to claim 12, wherein each fibre-coupled reflector comprises an optical fibre having an end cleaved to provide reflection of radiation within the optical fibre.

16. (canceled)

17. A method of forming a fibre-optic package comprising arranging two or more fibre-optic accelerometers in an array configuration, and performing a fused fibre coupling on a fibre optic connecting portion extending between connected accelerometers.

18. A method of fabricating a fibre-optic package comprising the steps of:
(i) taking first and second fibre-optic devices or components having first and second optical fibres respectively; and
(ii) coupling respective lengths of the first and second fibres by fused-fibre coupling.

19. A method according to claim 18, comprising the steps of:
(i) forming first, second and third individual fibre-optic accelerometers from a single optical fibre;
(ii) fused-fibre coupling a first fibre-coupled reflector to the fibre between the first and second accelerometers;
(iii) fused-fibre coupling a second fibre-coupled reflector to the fibre between the second and third accelerometers;
(iv) fused-fibre coupling a third fibre-coupled reflector to the fibre at an input of the first accelerometer; and
(v) fused-fibre coupling a fourth fibre-coupled reflector to the fibre at an output of the third accelerometer.

20. A method according to claim 18, wherein two fibres are fused-fibre coupled by the steps of twisting a length of one of the fibres around a length of the other and heating the region in which the fibres overlap to form a coupled region.

21. A method according to claim 20, further comprising the step of packaging the coupled region of the fibres.
